(19) United States
(12) Patent Application Publication
(10) Pub. No.: US 2019/0187853 A1
(43) Pub. Date: Jun. 20, 2019

(54) Touch Substrate and Driving Method Thereof, Display Panel and Driving Method Thereof

(71) Applicant: BOE TECHNOLOGY GROUP CO., LTD., Beijing (CN)

(72) Inventors: Xiaoliang DING, Beijing (CN); Haisheng WANG, Beijing (CN); Yingming LIU, Beijing (CN); Pengpeng WANG, Beijing (CN); Yanling HAN, Beijing (CN)

(21) Appl. No.: 16/323,160

(22) PCT Filed: Mar. 7, 2018
(86) PCT No.: PCT/CN2018/078283

§ 371 Date: Feb. 4, 2019

(30) Foreign Application Priority Data
Jul. 20, 2017 (CN) 201710596446.9

(51) Int. Cl. G06F 3/041; G06F 3/044; G06F 3/01; G02F 1/1333

(52) U.S. Cl. CPC G06F 3/0412; G06F 3/0416; G02F 1/13338; G06F 3/016; G06F 3/044

(57) ABSTRACT

A touch substrate, a display panel and driving methods thereof are provided. The touch substrate comprises: a driving layer configured to receive a touch driving signal or a reference signal; a touch layer configured to receive the touch driving signal or a frequency conversion signal and comprising touch sub-electrodes arranged in an array and configured to generate, upon sensing a touch, a touch signal; a control circuit configured to receive the touch signal, and provide, based on the touch signal, the frequency conversion signal to the touch sub-electrode generating the touch signal and the reference signal to the driving layer simultaneously; and a feedback layer contacting the driving layer and the touch layer, respectively, and configured to generate a touch feedback response in an area corresponding to the touch sub-electrode generating the touch signal based on the frequency conversion signal and the reference signal.

### CROSS-REFERENCE TO RELATED APPLICATION

The present application claims the priority of Chinese Patent Application No. 201710596446.9, filed on Jul. 20, 2017, the contents of which are incorporated herein in their entirety by reference.

### TECHNICAL FIELD

The present disclosure relates to the field of display technology, and in particular, relates to a touch substrate, a driving method of a touch substrate, a display panel and a driving method of a display panel.

### BACKGROUND

With the development of science and technology, display devices such as flat panel LCD (Liquid Crystal Display) and OLED (Organic Light-Emitting Diode) display devices have realized touch control.

A touch screen of a smart device brings various new experiences to a user. However, in spite of being convenient and quick, the touch screen also derives people of their experience of pressing a physical keyboard. On the other hand, people's demand for touch experience is very strong, as touch feedback can improve, to some extent, the experience of people using a touch screen. People expect to have experience of touching a real object while touching the screen. For example, in the case of playing the game Angry Bird on a touch screen, the user may expect to feel the elasticity of a rubber band when stretching a slingshot.

Appearance of electrostatic tactile feedback technology allows people to have a real tactile experience when touching a screen. Conventional electrostatic tactile feedback is generally implemented by attaching an electrostatic touch layer, which is separately fabricated, on a surface of the display device, and the display device usually adopts an optical touch technology to realize touch control. Since the electrostatic touch layer is closest to a finger, in the case of adopting a mainstream capacitive touch technology, the electrostatic touch layer will shield a capacitive touch signal, resulting in touch failure.

Therefore, how to obtain a better texture tactile experience of the physical keyboard on the touch screen while maintaining the convenience of the touch has become a technical problem to be solved urgently at present.

### SUMMARY

The present application provides a touch substrate, including a control circuit; and a driving layer, a feedback layer, and a touch layer, which are sequentially stacked, wherein the driving layer is configured to receive a touch driving signal or a reference signal; the touch layer is configured to receive the touch driving signal or a frequency conversion signal and includes a plurality of touch sub-electrodes arranged in an array, and the touch sub-electrode is configured to generate, upon sensing a touch, a touch signal and transmit the touch signal to the control circuit; the control circuit is configured to receive the touch signal, and provide, based on the touch signal, the frequency conversion signal to the touch sub-electrode that generates the touch signal and the reference signal to the driving layer simultaneously; and the feedback layer is in contact with the driving layer and the touch layer, respectively, and is configured to generate a touch feedback response in an area corresponding to the touch sub-electrode that generates the touch signal based on the frequency conversion signal and the reference signal.

According to an embodiment of the present disclosure, the feedback layer includes a piezoelectric material, and the feedback layer is configured to generate a vibration in an inverse piezoelectric manner based on the frequency conversion signal and the reference signal to simulate a tactility of a different material texture.

According to an embodiment of the present disclosure, the frequency conversion signal in a range of 50 MHz to 100 MHz corresponds to the tactility of a metal material texture, and the frequency conversion signal in a range of 500 kHz to 50 MHz corresponds to the tactility of a wood material texture.

According to an embodiment of the present disclosure, the driving layer has a planar structure; the feedback layer at least corresponds in shape to the touch sub-electrodes or has a planar structure.

There is provided a driving method for the above-described touch substrate, including a touch phase and a touch feedback phase, wherein: in the touch phase, a same touch driving signal is applied to the driving layer and the touch layer, the touch sub-electrode generates a touch signal upon sensing a touch and then transmits the touch signal to the control circuit; and in the touch feedback phase, the control circuit receives the touch signal, and based on the touch signal, provides a reference signal to the driving layer, and simultaneously provides a frequency conversion signal to the touch layer.

According to an embodiment of the present disclosure, a duration of the touch phase is the same as a duration of the touch feedback phase.

According to an embodiment of the present disclosure, the frequency conversion signal in a range of 50 MHz to 100 MHz corresponds to the tactility of a metal material texture, and the frequency conversion signal in a range of 500 kHz to 50 MHz corresponds to the tactility of a wood material texture.

There is provided a display panel including a display substrate and the above-described touch substrate, and the touch substrate is on a side of the display substrate close to a display side.

According to an embodiment of the present disclosure, the display substrate includes a color filter layer and an array layer opposite to each other; and liquid crystal between the color filter layer and the array layer, wherein the color filter layer includes a common electrode layer, and the common electrode layer also functions as the driving layer in the touch substrate.

There is provided a driving method for the above-described display panel, including a display phase, a touch phase, and a touch feedback phase, the display phase being prior to the touch phase, wherein: in the display phase, a reference signal is applied to the driving layer and the touch layer, and the display substrate performs display; in the touch phase, a same touch driving signal is applied to the driving layer and the touch layer, the touch sub-electrode generates a touch signal upon sensing a touch and then transmits the touch signal to the control circuit; and in the touch feedback phase, the control circuit receives the touch signal, and based on the touch signal, provides a reference signal to the driving layer, and simultaneously provides a frequency conversion signal to the touch layer.

According to an embodiment of the present disclosure, a duration of the display phase is 6 to 8 times as long as a duration of the touch phase during one frame period.

### BRIEF DESCRIPTION OF THE DRAWINGS

FIG. 1 is a schematic diagram of providing a texture tactile experience by using an electrostatic force technique in the related art;

FIG. 2 is a cross-sectional view of a touch substrate according to an embodiment of the present application;

FIG. 3 is a top view of a touch layer in FIG. 2;

FIG. 4 is a schematic diagram illustrating operation of a touch substrate according to an embodiment of the present application;

FIG. 5 is a flowchart of a driving method for a touch substrate according to an embodiment of the present application;

FIG. 6 is a timing diagram of a driving method for a touch substrate according to an embodiment of the present application;

FIG. 7 is a cross-sectional view of a display panel according to an embodiment of the present application;

FIG. 8 is a schematic diagram illustrating operation of a display panel according to an embodiment of the present application;

FIG. 9 is a flowchart of a driving method for a touch panel according to an embodiment of the present application; and

FIG. 10 is a timing diagram of a driving method for a display panel according to an embodiment of the present application.

### DETAILED DESCRIPTION

To enable those skilled in the art to better understand technical solutions of the present application, the present application will be further described in detail below with reference to the accompanying drawings and specific embodiments.

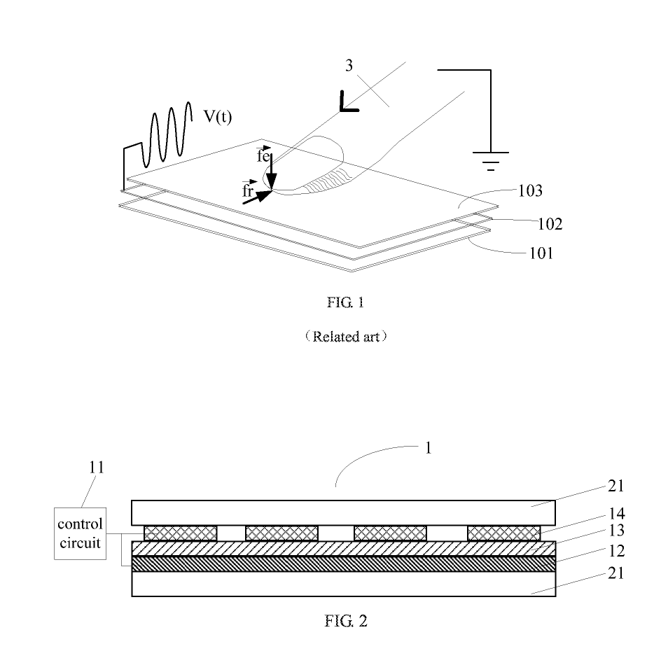

The appearance of electrostatic tactile feedback technology allows people to have a real tactile experience when touching a screen. As shown in FIG. 1, the structure includes, from bottom to top, a glass substrate 101, a transparent electrode 102 over the entire glass substrate 101, and an insulating layer 103. When an electrical signal V(t) is applied to the transparent electrode 102, electrostatic forces fe and fr are generated between a finger 3 and the transparent electrode 102, and the electrostatic forces fe and fr act on the finger 3 to cause a tactile experience.

Conventional electrostatic tactile feedback is generally achieved by attaching an electrostatic touch layer, which is separately fabricated, on a surface of a display device, and the display device usually adopts an optical touch technology to realize touch control. Since the electrostatic touch layer is closest to a finger, in the case of adopting the mainstream capacitive touch technology, the electrostatic touch layer will shield a capacitive touch signal, resulting in touch failure.

In view of the problem that experience of a physical keyboard obtained by pressing a conventional touch screen has an adverse impact on the touch effect, the present disclosure provides a touch substrate and a corresponding driving method. The touch substrate according to the embodiments of the present disclosure can generate a micro-vibration at the display surface to simulate different material textures that can be felt by a human body, thereby obtaining a better texture tactile experience of a physical keyboard on the touch screen while ensuring the touch effect.

FIG. 2 is a cross-sectional view illustrating a touch substrate 1 in an embodiment. The touch substrate 1 includes a control circuit 11; and a driving layer 12, a feedback layer 13 and a touch layer 14 which are sequentially stacked, and detailed description thereof will be given below.

The driving layer 12 is configured to receive a touch driving signal or a reference signal.

The touch layer 4 is configured to receive a touch driving signal or a frequency conversion signal. Referring to FIG. 3, the touch layer 14 includes a plurality of touch sub-electrodes 141 arranged in an array. The touch sub-electrode 141 generates a touch signal upon sensing a touch and transmits the touch signal to the control circuit 11.

The control circuit 11 is configured to receive the touch signal, and provide, based on the touch signal, a frequency conversion signal to the touch sub-electrode 141 that generates the touch signal, and a reference signal to the driving layer simultaneously.

The feedback layer 13 is in direct contact with the driving layer 12 and the touch layer 14, respectively, and is configured to generate, based on the frequency conversion signal and the reference signal, a touch feedback response in an area corresponding to the touch sub-electrode 141.

In FIG. 2, the driving layer 12 and the touch layer 14 are connected to the control circuit 11, respectively. The control circuit 11 is configured to process the received touch signal and an excitation effect of the touch signal, and apply the subsequent frequency conversion signal onto the touch sub-electrode in the touch layer. Needless to say, the touch substrate is a complicated circuit system, and the function of the control circuit 11 can be implemented by other component having a signal processing function in the touch substrate, which is not limited herein.

The control circuit 11 may be a dedicated circuit including various elements, or may be a processor, a microprocessor, or a microcontroller, which is not limited in the present disclosure.

Substrates 21 are provided at both sides of the touch substrate 1, respectively.

By having the feedback layer 13, a micro-vibration can generate at the display surface based on the touch signal, so as to simulate different material textures for a human body to feel. The feedback layer 13 may include a piezoelectric material and may generate a vibration in an inverse piezoelectric manner to simulate the tactility of different material textures. In the embodiment of FIG. 2, the feedback layer 13 is made of a piezoelectric material, the piezoelectric material can generate a vibration using the inverse piezoelectric effect based on a frequency difference between the frequency conversion signal on the touch sub-electrode 141 and the reference signal on the driving layer 12, and the generated vibration is mechanically transferred to the human body, so that the human body can feel the tactility of different material textures.

In one embodiment, the frequency conversion signal has a frequency in the range of 50 MHz to 100 MHz, and the frequency conversion signal in this range corresponds to the tactility of a metal texture. In another embodiment, the frequency conversion signal is in the range of 500 kHz to 50 MHz, and the frequency conversion signal in this range corresponds to the tactility of a wood texture. In other words, the frequency conversion signal causes the feedback layer 13 to generate a vibration as a feedback, and the touch feedback response may be in various forms depending on the frequency of the frequency conversion signal, so that the human body can feel the tactility of different material textures.

It is easy to understand that different tactile experiences can be obtained by using different frequency conversion signals. The frequency conversion signals corresponding to tactility of other material textures can be obtained through experiments or simulations, which is not be described in detail herein.

In the touch substrate of the embodiments, the driving layer 12 is provided to have a planar structure; the feedback layer 13 is disposed at least correspondingly to the touch sub-electrodes 141 or is provided to have a planar structure. In another embodiment, the driving layer 12 and the touch layer 14 are both provided to have a planar structure, and in this manner, the signal generation area is large, which can better ensure the touch control and touch feedback effects.

In the embodiment of FIG. 2, the touch layer 14 is designed to have a single layer, and each of the touch sub-electrodes 141 in the touch layer 14 forms a sensor. The entire surface of the feedback layer 13 is coated with a piezoelectric material and under the sensors, and the sensors are in direct contact with the piezoelectric material. The driving layer 12 formed as a planar structure is under and in direct contact with the piezoelectric material. FIG. 3 is a schematic diagram of the touch sub-electrodes 141 in the touch layer 14, the plurality of touch sub-electrodes 141 are arranged uniformly in an array. In an embodiment according to the present application, the piezoelectric material may be a generalized piezoelectric material (e.g., zinc oxide (ZnO)), or other polymer material having a piezoelectric property. The driving layer may be formed of a transparent conductive material (e.g., Indium Tin Oxide (ITO)).

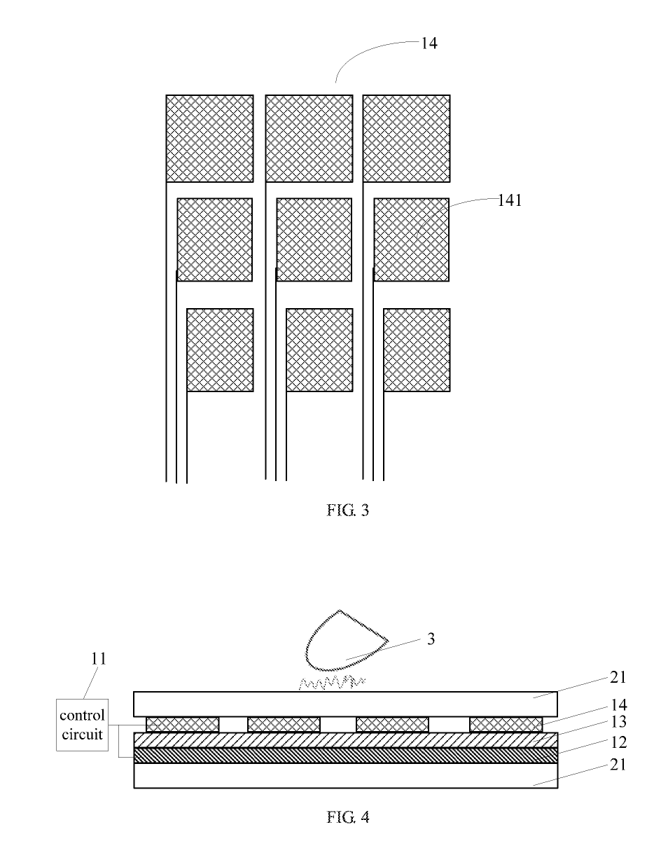

FIG. 4 shows an operating principle of the touch substrate 1 according to the embodiment of FIG. 2. The operating principle is as follows: a corresponding touch sub-electrode 141 in the touch layer 14 generates a touch signal upon sensing a touch of a finger 3, and feeds back the touch signal to the control circuit 11; based on the touch signal, the control circuit 11 provides a frequency conversion signal for a set period of time to the touch sub-electrode 141 that generates the touch signal, and simultaneously provides a reference signal to the driving layer 12; there is a frequency difference between the frequency conversion signal applied onto the touch sub-electrode 141 and the reference signal applied onto the driving layer 12, and the piezoelectric material in an area of the feedback layer 13 corresponding to the touch sub-electrode 141 generates a vibration due to the inverse piezoelectric effect, and the vibration is mechanically transferred to the human body, so that the human body feels the tactility of different material textures.

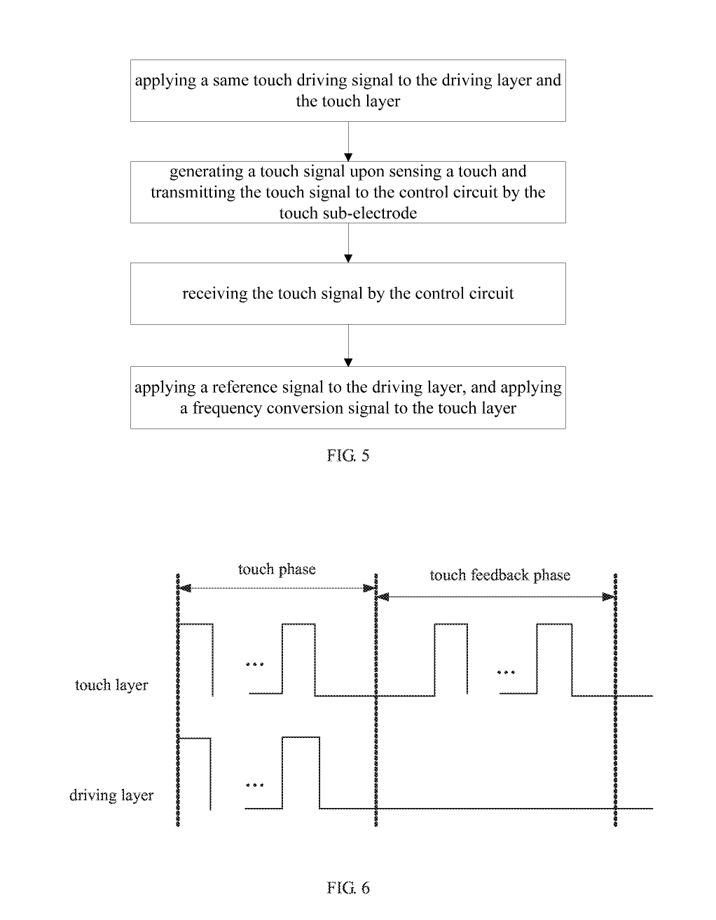

Correspondingly, the present application further provides a driving method for the touch substrate. As shown in FIG. 5, the driving method includes a touch phase and a touch feedback phase, and includes the steps as follows.

In the touch phase, a same touch driving signal is applied to the driving layer 12 and the touch layer 14. The touch sub-electrode 141 generates a touch signal once sensing a touch and transmits the touch signal to the control circuit 11. In the touch feedback phase, the control circuit 11 receives the touch signal, and based on the touch signal, provides a reference signal to the driving layer 12, and simultaneously provides a frequency conversion signal to the touch layer 14.

In an embodiment, the duration of the touch phase is the same as the duration of the touch feedback phase. In another embodiment, the durations of the touch phase and the touch feedback phase may be set such that the touch phase and the touch feedback phase are properly allocated in a short period of time. Needless to say, depending on different applications, the durations of the touch phase and the touch feedback phase may be changed to achieve different effects, which will not be described in detail herein. In another embodiment, in the case where the touch sub-electrodes 141 do not sense a touch during the touch phase, the control circuit 11 will not enter the touch feedback phase for lack of excitation of the touch signal, and in this case, the duration of the touch feedback phase in the presence of a touch signal may be adjusted for monitoring a touch action or not performing any action, which is not limited herein.

FIG. 6 is a timing diagram corresponding to a driving method for a touch substrate in an embodiment. In the touch phase, the touch driving signal is applied to both the touch layer 14 and the driving layer 12 to ensure that loading of the touch sub-electrode 141 (touch sensor loading) is minimized. In the touch feedback phase, the driving layer 12 is applied with the reference level Vcom, and the touch sub-electrode 141 in the touch layer 14 is applied with the frequency conversion signal; since a frequency difference is formed between the touch sub-electrode 141 and the driving layer 12, the piezoelectric material between the touch sub-electrode 141 and the driving layer 12 is driven by the frequency conversion signal, and generates a micro-vibration under the action of the inverse piezoelectric effect; the vibration exerts a force on the finger, so that it feels like touching a surface texture of the material by the finger.

In an embodiment according to the driving method, the frequency conversion signal has a frequency in the range of 50 MHz to 100 MHz, and the frequency conversion signal in this range corresponds to the tactility of a metal texture. In another embodiment, the frequency conversion signal is in the range of 500 kHz to 50 MHz, and the frequency conversion signal in this range corresponds to the tactility of a wood texture. The feedback layer 13 generates a vibration as a feedback based on the frequency conversion signal. The form of the touch feedback response varies as the frequency of the frequency conversion signal varies, so that the human body can feel the tactility of different material textures.

In the touch substrate and the corresponding driving method thereof according to the embodiments, the touch layer senses or receives different signals at different phases to realize touch control, and allows the feedback layer connected thereto to generate a vibration correspondingly, so that a micro-vibration can be generated at the surface of the touch substrate to simulate different material textures to be felt by the human body, thereby obtaining a better texture tactile experience of a physical keyboard while ensuring the touch effect.

Another embodiment of the present application provides a display panel that can obtain a better texture tactile experience of a physical keyboard while ensuring touch effect.

The display panel includes a display substrate 2, and further includes the touch substrate 1 in the above embodiments. The touch substrate 1 is disposed on a side of the display substrate 2 close to the display side. The display substrate 2 may be a liquid crystal display substrate or an organic light emitting diode display substrate. In the embodiment, since the touch substrate 1 is disposed in the display panel, based on the operating principle of the touch substrate as described above, a micro-vibration can be generated at the display surface based on the touch signal, so as to simulate different material textures to be felt by a human body.

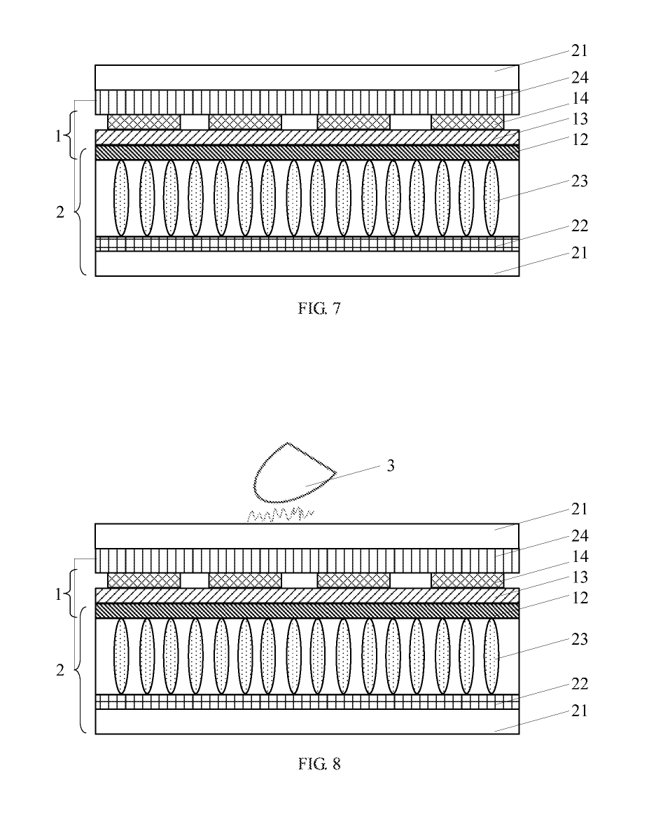

Considering the structure and thinning process of the device, for example, for a TN type liquid crystal display substrate, a touch function may be incorporated into the display substrate by way of single layer in-cell (SLIC). As shown in FIG. 7, substrates 21 are provided at both sides of the display panel, respectively. The display substrate 2 includes a color filter layer 24 and an array layer 22 opposite to each other; and liquid crystal 23 disposed between the color filter layer 24 and the array layer 22. The color filter layer 24 includes a common electrode layer, and the common electrode layer also serves as the driving layer 12 in the touch substrate 1. In this case, the common electrode layer in the TN type liquid crystal display panel can function as not only the common electrode for display but also the driving layer 12 for touch control, which can further simplify the structure of the display panel.

In the above-described TN type liquid crystal display panel, a piezoelectric material is provided between the common electrode of the display substrate 2 and the sensors of the touch substrate 1, so that the common electrode of the display substrate 2 also serves as the driving layer 12 of the touch substrate 1, thereby achieving a more compact structure. Needless to say, the touch substrate 1 according to the embodiment of FIG. 2 may also be combined with other type of display substrate 2 (e.g., a liquid crystal display substrate of other display mode, or an OLED display substrate) to form a display panel, and in this case, it only needs to attach the touch substrate 1 to the display side of the display substrate 2, which will not be described in detail herein.

FIG. 8 shows the operating principle of a display panel according to an embodiment. In the embodiment, a finger 3 touches the display panel, and the corresponding touch sub-electrode 141 generates a touch signal upon sensing the touch of the finger 3, and feeds back the touch signal to the control circuit 11; based on the touch signal, the control circuit 11 provides a frequency conversion signal for a set period of time to the touch sub-electrode 141 that generates the touch signal, and simultaneously provides a reference signal to the driving layer 12; there is a frequency difference generated between the frequency conversion signal applied onto the touch sub-electrode 141 and the reference signal applied onto the driving layer 12, and the piezoelectric material in an area of the feedback layer 13 corresponding to the touch sub-electrode 141 generates a vibration due to the inverse piezoelectric effect, and the vibration is mechanically transferred to the human body, so that the human body feels the tactility of different material textures. In this manner, by applying different frequency conversion signals on different touch sub-electrodes 141, different material textures appear in different areas, corresponding to different touch sub-electrodes 141, of the surface of the display panel, and real-time response can be realized. In the case of changing the frequency conversion signal, the material texture may be changed in the corresponding area.

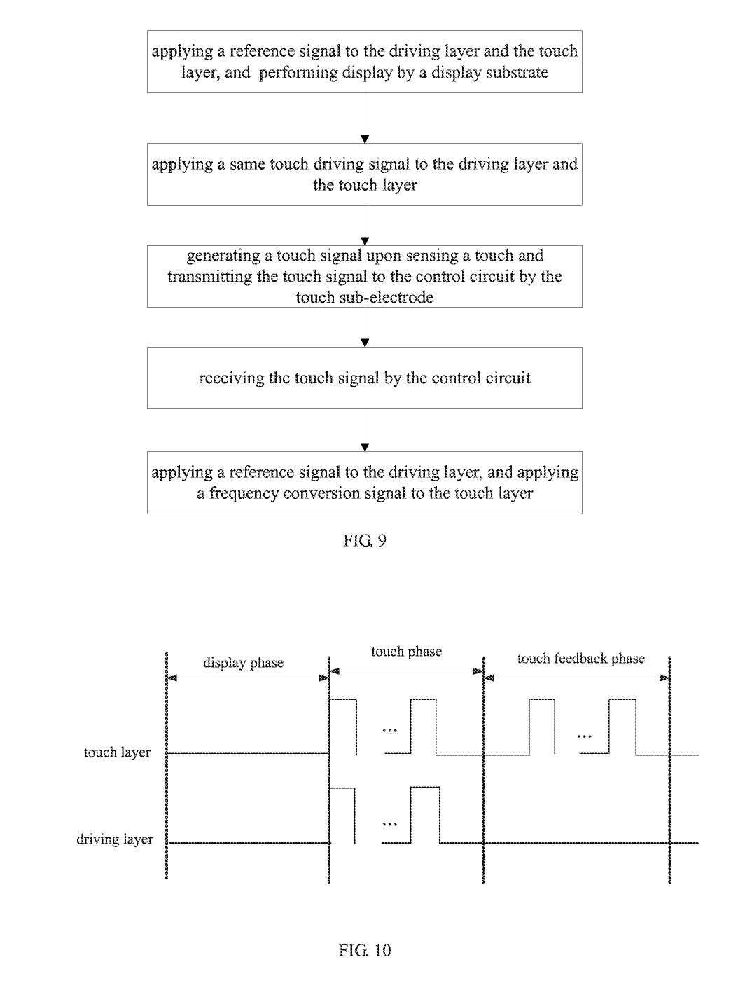

In another embodiment, as shown in FIG. 9, the present application further provides a driving method for the display panel, the method includes a display phase, a touch phase, and a touch feedback phase, and the display phase is prior to the touch phase. The driving method may include the following steps.

In the display phase, a reference signal of a fixed level is applied to both the driving layer 12 and the touch layer 14, and the display substrate performs display. In the touch phase, a same touch driving signal is applied to the driving layer 12 and the touch layer 14, and the touch sub-electrode 141 generates a touch signal once sensing a touch and transmits the touch signal to the control circuit 11. In the touch feedback phase, the control circuit 11 receives the touch signal, and based on the touch signal, provides a reference signal to the driving layer 12, and simultaneously provides a frequency conversion signal to the touch layer 14.

In an embodiment, during one frame period, the duration of the display phase is 6 to 8 times as long as the duration of the touch phase. In another embodiment, by setting the time relationship between the display phase and the touch phase or touch feedback phase, not only the display effect but also the touch effect can be ensured. In another embodiment, in the case where the touch sub-electrodes 141 do not sense a touch during the touch phase, the control circuit 11 will not enter the touch feedback phase for lack of excitation of the touch signal, and in this case, the duration of the touch feedback phase in the presence of a touch signal may be adjusted for performing display, monitoring a touch action or not performing any action, which is not limited herein.

FIG. 10 is a timing diagram for a driving method for a display panel according to an embodiment of the present application. In the display phase, the touch layer 14 and the driving layer 12 are both applied with a display reference level Vcom. In the touch phase, the touch layer 14 and the driving layer 12 are both applied with a touch driving signal to ensure that loading of the touch sub-electrode 141 is minimized. In the touch feedback phase, the driving layer 12 is applied with the reference level Vcom, and the touch layer 14 is applied with the frequency conversion signal; since a frequency difference is formed between the touch sensor (i.e., touch sub-electrode 141) in the touch layer 14 and the common electrode, the piezoelectric material between the touch sub-electrode 141 and the common electrode is driven by the frequency conversion signal, and generates a micro-vibration under the action of the inverse piezoelectric effect of the piezoelectric material, so that a micro-vibration occurs at the surface of the color filter substrate; the vibration exerts a force on the finger, so that the tactility of different material textures can be felt by a finger.

The display panel may any product or component with a display function, such as a desktop computer, a tablet computer, a notebook computer, a mobile phone, a PDA, a GPS, a car display, a projection display, a camera, a digital camera, an electronic watch, a calculator, an electronic instrument, an instrument, an LCD panel, an electronic paper, a television, a display, a digital photo frame, a navigator, etc., and may be applied to various fields such as public display and virtual display.

In the display panel and the corresponding driving method thereof according to the embodiments, the function of the touch substrate is incorporated into the display substrate by way of in-cell, the touch layer senses or receives different signals at different phases to realize touch control, and allows the feedback layer connected thereto to generate a vibration correspondingly, so that a micro-vibration can be generated at the surface of the touch substrate to simulate different material textures to be felt by a human body, thereby obtaining a better texture tactile experience of a physical keyboard while ensuring the touch effect. In addition, since the electrodes of the touch substrate and the display substrate are shared, the structure of the display panel and the driving method for the display panel are greatly simplified.

It should be understood that, the above embodiments are only exemplary embodiments for the purpose of explaining the principle of the present disclosure, but the present disclosure is not limited thereto. For one of ordinary skill in the art, various improvements and modifications may be made without departing from the spirit and essence of the present disclosure.

1. A touch substrate, comprising: a control circuit; and a driving layer, a feedback layer, and a touch layer, which are sequentially stacked, wherein
the driving layer is configured to receive a touch driving signal or a reference signal;
the touch layer is configured to receive the touch driving signal or a frequency conversion signal and comprises a plurality of touch sub-electrodes arranged in an array, and the touch sub-electrode is configured to generate, upon sensing a touch, a touch signal and transmit the touch signal to the control circuit;
the control circuit is configured to receive the touch signal, and provide, based on the touch signal, the frequency conversion signal to the touch sub-electrode that generates the touch signal and the reference signal to the driving layer simultaneously; and
the feedback layer is in contact with the driving layer and the touch layer, respectively, and is configured to generate a touch feedback response in an area corresponding to the touch sub-electrode that generates the touch signal based on the frequency conversion signal and the reference signal.

2. The touch substrate of claim 1, wherein the feedback layer comprises a piezoelectric material, and the feedback layer is configured to generate a vibration in an inverse piezoelectric manner based on the frequency conversion signal and the reference signal to simulate a tactility of a different material texture.

3. The touch substrate of claim 1, wherein the frequency conversion signal in a range of 50 MHz to 100 MHz corresponds to the tactility of a metal material texture, and the frequency conversion signal in a range of 500 kHz to 50 MHz corresponds to the tactility of a wood material texture.

4. The touch substrate of claim 1, wherein
the driving layer has a planar structure; and
the feedback layer at least corresponds in shape to the touch sub-electrodes; or has a planar structure.

5. A driving method for a touch substrate, the touch substrate comprising: a control circuit; and a driving layer, a feedback layer, and a touch layer, which are sequentially stacked, wherein the driving layer is configured to receive a touch driving signal or a reference signal; the touch layer is configured to receive the touch driving signal or a frequency conversion signal and comprises a plurality of touch sub-electrodes arranged in an array, and the touch sub-electrode is configured to generate, upon sensing a touch, a touch signal and transmit the touch signal to the control circuit; the control circuit is configured to receive the touch signal, and provide, based on the touch signal, the frequency conversion signal to the touch sub-electrode that generates the touch signal and the reference signal to the driving layer simultaneously; and the feedback layer is in contact with the driving layer and the touch layer, respectively, and is configured to generate a touch feedback response in an area corresponding to the touch sub-electrode that generates the touch signal based on the frequency conversion signal and the reference signal, and
the driving method comprises a touch phase and a touch feedback phase, wherein:
in the touch phase, the control circuit applies a same touch driving signal to the driving layer and the touch layer, the touch sub-electrode generates a touch signal upon sensing a touch and then transmits the touch signal to the control circuit; and
in the touch feedback phase, the control circuit receives the touch signal, and based on the touch signal, provides a reference signal to the driving layer, and simultaneously provides a frequency conversion signal to the touch layer.

6. The driving method of claim 5, wherein a duration of the touch phase is the same as a duration of the touch feedback phase.

7. The driving method of claim 5, wherein the frequency conversion signal in a range of 50 MHz to 100 MHz corresponds to the tactility of a metal material texture, and the frequency conversion signal in a range of 500 kHz to 50 MHz corresponds to the tactility of a wood material texture.

8. A display panel, comprising a display substrate and the touch substrate of claim 1, wherein the touch substrate is on a side of the display substrate close to a display side.

9. The display panel of claim 8, wherein the display substrate comprises: a color filter layer and an array layer opposite to each other, and liquid crystal between the color filter layer and the array layer, the color filter layer comprises a common electrode layer, and the common electrode layer also functions as the driving layer in the touch substrate.

10. A driving method for a display panel, the display panel comprising a display substrate and the touch substrate of claim 1, the touch substrate being on a side of the display substrate close to a display side,
the driving method comprising a display phase, a touch phase, and a touch feedback phase, the display phase being prior to the touch phase, wherein:
in the display phase, a reference signal is applied to the driving layer and the touch layer, and the display substrate performs display;
in the touch phase, a same touch driving signal is applied to the driving layer and the touch layer, the touch sub-electrode generates a touch signal upon sensing a touch and then transmits the touch signal to the control circuit; and
in the touch feedback phase, the control circuit receives the touch signal, and based on the touch signal, provides a reference signal to the driving layer, and simultaneously provides a frequency conversion signal to the touch layer.

11. The driving method of claim 10, wherein a duration of the display phase is 6 to 8 times as long as a duration of the touch phase during one frame period.

12. A display panel, comprising a display substrate and the touch substrate of claim 2, wherein the touch substrate is on a side of the display substrate close to a display side.

13. The display panel of claim 12, wherein the display substrate comprises: a color filter layer and an array layer opposite to each other, and liquid crystal between the color filter layer and the array layer, the color filter layer comprises a common electrode layer, and the common electrode layer also functions as the driving layer in the touch substrate.

14. A display panel, comprising a display substrate and the touch substrate of claim 3, wherein the touch substrate is on a side of the display substrate close to a display side.

15. The display panel of claim 14, wherein the display substrate comprises: a color filter layer and an array layer opposite to each other, and liquid crystal between the color filter layer and the array layer, the color filter layer comprises a common electrode layer, and the common electrode layer also functions as the driving layer in the touch substrate.

16. A display panel, comprising a display substrate and the touch substrate of claim 4, wherein the touch substrate is on a side of the display substrate close to a display side.

17. The display panel of claim 16, wherein the display substrate comprises: a color filter layer and an array layer opposite to each other, and liquid crystal between the color filter layer and the array layer, the color filter layer comprises a common electrode layer, and the common electrode layer also functions as the driving layer in the touch substrate.

18. A driving method for a display panel, the display panel comprising a display substrate and the touch substrate of claim 2, the touch substrate being on a side of the display substrate close to a display side,
the driving method comprising a display phase, a touch phase, and a touch feedback phase, the display phase being prior to the touch phase, wherein:
in the display phase, a reference signal is applied to the driving layer and the touch layer, and the display substrate performs display;
in the touch phase, a same touch driving signal is applied to the driving layer and the touch layer, the touch sub-electrode generates a touch signal upon sensing a touch and then transmits the touch signal to the control circuit; and
in the touch feedback phase, the control circuit receives the touch signal, and based on the touch signal, provides a reference signal to the driving layer, and simultaneously provides a frequency conversion signal to the touch layer.

19. The driving method of claim 18, wherein a duration of the display phase is 6 to 8 times as long as a duration of the touch phase during one frame period.

20. A driving method for a display panel, the display panel comprising a display substrate and the touch substrate of claim 3, the touch substrate being on a side of the display substrate close to a display side,
the driving method comprising a display phase, a touch phase, and a touch feedback phase, the display phase being prior to the touch phase, wherein:
in the display phase, a reference signal is applied to the driving layer and the touch layer, and the display substrate performs display;
in the touch phase, a same touch driving signal is applied to the driving layer and the touch layer, the touch sub-electrode generates a touch signal upon sensing a touch and then transmits the touch signal to the control circuit; and
in the touch feedback phase, the control circuit receives the touch signal, and based on the touch signal, provides a reference signal to the driving layer, and simultaneously provides a frequency conversion signal to the touch layer.
